(19) United States
(12) Patent Application Publication
(10) Pub. No.: US 2021/0381869 A1
(43) Pub. Date: Dec. 9, 2021

(54) SEQUENTIAL VOLUMETRIC FLOWMETER

(71) Applicant: Vianney RABHI, LYON (FR)

(72) Inventor: Vianney RABHI, LYON (FR)

(21) Appl. No.: 17/336,514

(22) Filed: Jun. 2, 2021

Related U.S. Application Data
(60) Provisional application No. 63/033,931, filed on Jun. 3, 2020.

(51) Int. Cl. G01F 3/16

(52) U.S. Cl. CPC G01F 3/16

(57) ABSTRACT

The sequential volumetric flowmeter includes a static measurement enclosure which is connected to a fluid inlet duct and a fluid outlet duct and in which a movable separator can move to form a variable input volume and a variable output volume, a mobile return spring tending to reduce the variable input volume, the minimum volume of which is fixed by a start-of-stroke static stop and a movable start-of-stroke stop; a bypass valve controlled by a valve actuator can put the variable input volume in communication with the variable output volume, and a displacement measurement unit informing a computer about the position of the movable separator.

### BACKGROUND OF THE INVENTION

### Field of the Invention

The present invention relates to a sequential volumetric flowmeter, particularly provided to precisely measure the volume and/or mass flow of a gas, over a large amplitude.

### Description of the Related Art

Said flowmeter according to the present invention is particularly suitable for the implementation of the valve ignition pre-chamber which was the subject of patent No. FR 3,061,743 published on Aug. 16, 2019, said patent belonging to the applicant.

Said pre-chamber provides in particular that a pilot charge is injected into a stratification cavity by a stratification injector, said charge consisting of an easily flammable air-fuel mixture previously pressurized by compression means.

The invention according to patent FR 3,061,743 is particularly intended for the automotive market. However, said market is very sensitive to costs, weight and size of any equipment, which must remain as low as possible. The automotive market is also very demanding in terms of robustness, reliability, service life, and maintenance.

The valve ignition pre-chamber according to patent FR 3,061,743 relates to this context, said pre-chamber requiring both high flow metering precision of the air-fuel mixture which constitutes the pilot charge, and great control over the amount of pilot charge injected into the stratification cavity at each cycle.

To achieve said precision and control, it is necessary to know precisely the mass flow rate of air introduced into the stratification cavity by the stratification injector. This information is necessary for, firstly, adding to said air the quantity of fuel necessary in order to obtain the desired air/fuel ratio for the pilot charge, and secondly, to control the stratification injector so that the latter introduces effectively the quantity of mixture sought in the stratification cavity.

Implementing the valve ignition pre-chamber according to patent FR 3,061,743 therefore requires the availability of an air mass flowmeter meeting all the requirements associated with this application.

It is to be noted that many types of flowmeter exist, being either a flowmeter with depressogenic member, a Pitot tube, ludion, cup, propeller or turbine flowmeter, a vane, ionic, ultrasonic, electromagnetic flowmeter, a Coriolis effect, Karman vortex or vortex effect flowmeter, a hot wire or film flowmeter, or thermal mass flowmeter.

Among the embodiments of flowmeters known to those skilled in the art are also the volumetric flowmeters, which alternately fill and empty with the fluid to be measured, said flowmeters possibly having a reciprocating, rotary or oscillating piston, or else with a membrane, a paddle or gears.

In addition to meeting the various requirements of the automotive industry, the flowmeter necessary for the implementation of the valve ignition pre-chamber according to patent FR 3,061,743 must be capable of precisely measuring the mass flow rate of the passing air over a large flow amplitude, which may vary by a factor of one hundred and fifty or more, which only very few flowmeters allow.

In addition, the flowmeter necessary for the implementation of said pre-chamber must be capable to operate under a relatively high pressure, of the order of fifty bars, and at variable temperature ranging from minus thirty degrees Celsius to over one hundred fifty degrees Celsius.

Finally, said flowmeter must be capable of withstanding the vibrations produced by a reciprocating internal combustion engine without damaging the accuracy and durability of said flowmeter. As previously mentioned, despite this set of requirements, said flowmeter must remain compact, reliable, robust and inexpensive.

### SUMMARY OF THE INVENTION

It is therefore primarily to implement the valve ignition pre-chamber according to patent FR 3,061,743 that, according to a particular embodiment, the sequential volumetric flowmeter according to the invention:
offers high precision in volume and mass flow measurement;
measures flow over a min/max range of one to one hundred and fifty or more;
can operate over a wide temperature range, compatible with the requirements of automotive engines;
is insensitive to vibrations produced by a reciprocating internal combustion engine, said vibrations not affecting the measurement accuracy of said flowmeter;
has a durability, robustness and reliability compatible with the automotive industry;
requires no special maintenance;
is lightweight and compact.

It is to be understood that the sequential volumetric flowmeter according to the invention can be applied not only to the valve ignition pre-chamber according to patent FR 3,061,743, but also to any other application, whatever the type or field, which requires an accurate measurement of the volumetric and/or mass flow rate of a gas or a liquid.

The sequential volumetric flowmeter according to the present invention is provided for measuring the flow rate of a fluid, said flowmeter comprising:
A static measurement enclosure connected, on the one hand, to a fluid inlet duct through which the fluid enters said enclosure, and, on the other hand, to a fluid outlet duct through which the fluid exits said enclosure;
At least one movable separator which can move in a sealed manner inside the static measurement enclosure, one surface located on the input volume side of said separator forming with said enclosure a variable input volume connected to the fluid inlet duct, and one surface located on the output volume side of said separator forming with said enclosure a variable output volume connected to the fluid outlet duct;
At least one mobile return spring which bears directly or indirectly in the static measurement enclosure to push or pull the movable separator in the direction of the variable input volume, said spring tending, on the one hand, to reduce the internal volume of the variable input volume and, on the other hand, to increase the pressure of the fluid contained in said volume;
At least one start-of-stroke static stop fixed with respect to the static measurement enclosure, said stop being capable to come into contact with a movable start-of-stroke stop fixed with respect to the movable separator, the two stops defining the minimum volume of the variable input volume when they are in contact with one another;
At least one bypass valve, the opening of which is controlled by a valve actuator, said valve putting directly or indirectly, when it is open, the variable input volume in communication with the variable output volume via a transfer channel;
Displacement measurement means which provide information to a computer about the position of the movable separator relative to the static measurement enclosure.
The sequential volumetric flowmeter according to the present invention comprises a movable separator which consists of a separating piston which moves in a separator cylinder which is formed by the inside of the static measurement enclosure, piston sealing means providing a seal between said piston and said cylinder.
The sequential volumetric flowmeter according to the present invention comprises piston sealing means which consists of a flexible diaphragm.
The sequential volumetric flowmeter according to the present invention comprises a movable separator which consists of a separation gaiter, one end of which being fixed in a sealed manner inside the static measurement enclosure, and the other end of which being sealed by a movable spring cup on which bears the mobile return spring.
The sequential volumetric flowmeter according to the present invention comprises a bypass valve which includes a bypass flap which can rest in a sealed manner on a flap seat formed in the variable input volume and fixed with respect to the static measurement enclosure, said flap being capable to move away from said seat by moving towards the interior of the variable input volume, whereas, when said flap rests on said seat, its face oriented towards the variable input volume forms the start-of-stroke static stop.

The sequential volumetric flowmeter according to the present invention comprises a bypass flap which has a flap opening movable stop which is capable to come into contact with a flap opening fixed stop fixed with respect to the static measurement enclosure, the two stops determining, when they are in contact with each other, the maximum distance which can separate the bypass flap from the flap seat with which it cooperates.

The sequential volumetric flowmeter according to the present invention comprises a flap spring which tends to move the bypass flap away from the flap seat with which it cooperates, the force produced by said spring being less than the force exerted on the bypass flap by the pressure of the fluid contained in the variable input volume when, on the one hand, said flap rests on said seat, and that, on the other hand, said pressure is greater than that of the fluid contained in the variable output volume as a result of the force exerted by the mobile return spring on the movable separator.

The sequential volumetric flowmeter according to the present invention comprises a valve actuator which consists of a magnetizable metal member which is mechanically connected to the bypass flap, said member being capable of imparting movement to said flap when it is attracted by a magnetic field produced by an actuator coil when the latter is traversed by an electric current.

The sequential volumetric flowmeter according to the present invention comprises a valve actuator which consists of a lifting linkage mechanically connected to the movable separator, said linkage having at least one actuator lifting stop which, firstly, contacts a flap lift stop fixed with respect to the bypass flap when the variable input volume has reached a predetermined volume and which then moves said flap away from the flap seat with which it cooperates as a result of the movement of the movable separator.

The sequential volumetric flowmeter according to the present invention comprises a transfer channel which is closed by a retaining flap held in contact with a retaining seat by a retaining spring, the latter letting said flap move away from said seat and open said channel only as from a determined pressure, so that the fluid coming from the variable input volume circulates in said channel while, at the same time, a retaining nozzle allows said fluid to pass through said channel even when the retaining flap is in contact with the retaining seat.

The sequential volumetric flowmeter according to the present invention comprises displacement measurement means which consist of a measurement rack which is fixed with respect to the movable separator and which, when moving with said separator, rotatably drives a measurement pinion which in turn rotatably drives, directly or by means of a mechanical multiplier, an impulse wheel fitted on its periphery with regularly distributed impulse generators, said wheel cooperating with impulse sensing means fixed with respect to the static measurement enclosure and in front of which the impulse generators pass, said sensing means transforming the passage of each impulse generator into an electrical signal transmitted to the computer.

The sequential volumetric flowmeter according to the present invention comprises a measurement pinion which drives the impulse wheel via a freewheel.

The sequential volumetric flowmeter according to the present invention comprises an impulse wheel which is connected to the static measurement enclosure via a freewheel.

The sequential volumetric flowmeter according to the present invention comprises a measurement pinion which drives, in addition to the impulse wheel and by means of a balancing rack, a balancing mass in longitudinal translation opposite the direction of the movement of the movable separator which takes place simultaneously, the relative speed and weight of said mass and of said rack being calculated so that when said mass and said rack move, they produce inertia forces of the same intensity as those produced at the same time by said separator and the measurement rack with which it cooperates.

The sequential volumetric flowmeter according to the present invention comprises displacement measurement means consisting of an impulse spindle which is provided with impulse generators along its length, and which is fixed with respect to the movable separator so that when said spindle moves with said separator, the impulse generators passing in front of impulse capture means which are fixed with respect to the static measurement enclosure and which transform the passage of each impulse generator into an electrical signal transmitted to the computer.

The sequential volumetric flowmeter according to the present invention comprises displacement measurement means consisting of a separator end-of-stroke sensor which is fixed with respect to the static measurement enclosure or to the moveable separator, said sensor transmitting an electrical signal to the computer when the variable input volume reaches a predefined maximum magnitude.

The sequential volumetric flowmeter according to the present invention comprises a movable separator which is directly or indirectly connected to the static measurement enclosure by a separator damper.

The sequential volumetric flowmeter according to the present invention comprises a pressure sensor and/or a temperature sensor which directly or indirectly measures the pressure and/or temperature prevailing in the variable input volume and/or the variable output volume.

### BRIEF DESCRIPTION OF THE DRAWINGS

The following description in relation to the attached drawings, which are supplied as non-limiting examples, will allow for a better understanding of the invention, the characteristics it has, and the advantages it is likely to provide:

FIG. 1 is a schematic cross-sectional view of the sequential volumetric flowmeter according to the invention as it may be used to implement the valve ignition pre-chamber according to patent FR 3,061,743 on a reciprocating internal combustion engine, the movable separator being shown at mid-ascending stroke and being formed by a separating piston whose piston sealing means are constituted by a flexible diaphragm, said piston moving in a separator cylinder and being connected to the static measurement enclosure by a separator flap, the displacement measurement means being constituted by an impulse spindle fixed with respect to the movable separator and having impulse slots passing in front of a “Hall” effect sensor.

FIG. 2 is a schematic cross-sectional view of the sequential volumetric flowmeter according to the invention and according to the embodiment shown in FIG. 1, the separating piston having reached its top dead center and beginning its descent in the direction of the start-of-stroke static stop after the bypass valve has been actuated to open by the valve actuator.

FIG. 3 is a schematic cross-sectional view of the sequential volumetric flowmeter according to the invention and according to the embodiment shown in FIG. 1, the separating piston having reached its bottom dead center and having come into contact with the start-of-stroke static stop, which, in this case, is constituted by the bypass valve, which has had the effect of pressing the latter against the flap seat with which it cooperates.

FIG. 4 is a schematic cross-sectional view of the sequential volumetric flowmeter according to the invention, the movable separator being shown at the start of its ascending stroke and consisting of a separating piston which can move in a separator cylinder, said piston receiving piston sealing means formed by a lip seal known per se, the displacement measurement means being configured as a potentiometric displacement sensor, the valve actuator consisting of a lifting linkage mechanically connected to the movable separator.

FIG. 5 is a schematic cross-sectional view of the sequential volumetric flowmeter according to the invention and according to the embodiment shown in FIG. 4, the movable separator being shown in the vicinity of the end of its ascending stroke so that the lifting linkage begins to move the bypass flap away from the flap seat with which it cooperates.

FIG. 6 is a schematic cross-sectional view of the sequential volumetric flowmeter according to the invention and according to the embodiment shown in FIG. 4, the movable separator being shown at its descending mid-stroke after the bypass flap has been moved away from the flap seat with which it cooperates firstly by the lifting linkage, then by the flap spring, so that the variable input volume has been placed in communication with the variable output volume.

FIG. 7 is a schematic cross-sectional view of the sequential volumetric flowmeter according to the invention, the movable separator consisting of a separation gaiter while the displacement measurement means are formed of a measurement rack fixed with respect to the movable separator, said rack rotatably driving a measurement pinion which in turn drives an impulse wheel via a mechanical multiplier.

FIG. 8 is a schematic cross-sectional view of the sequential volumetric flowmeter according to the invention and according to the embodiment shown in FIG. 7, the variable input volume being maximum, and the bypass flap is kept at maximum distance from the flap seat with which it cooperates by the flap spring.

FIG. 9 is a three-dimensional view of the sequential volumetric flowmeter according to the invention and according to the embodiment shown in FIG. 7, the static measurement enclosure being not shown to allow the main internal components of said flowmeter to be visible.

FIG. 10 is a three-dimensional sectional view of the sequential volumetric flowmeter according to the invention and according to the embodiment shown in FIG. 7.

### DESCRIPTION OF THE PREFERRED EMBODIMENTS

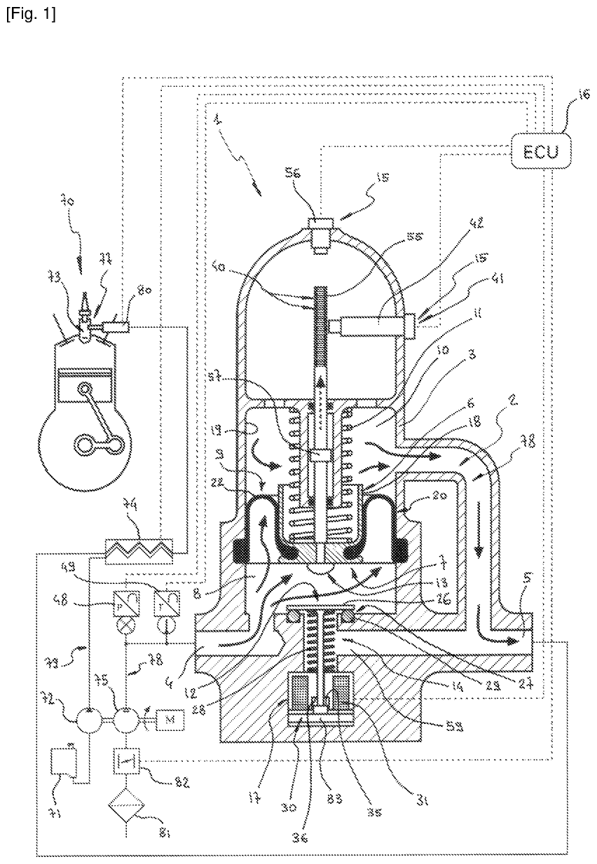

The sequential volumetric flowmeter 1 according to the invention, various details of its components, variants, and accessories are shown in FIGS. 1 to 10. Said flowmeter 1 is provided for measuring the flow rate of a fluid 2.

As shown in FIGS. 1 to 10, the sequential volumetric flowmeter 1 according to the invention comprises a static measurement enclosure 3 connected, on the one hand, to a fluid inlet duct 4 through which the fluid 2 enters said enclosure 3, and, on the other hand, to a fluid outlet duct 5 through which the fluid 2 leaves said enclosure 3.

The sequential volumetric flowmeter 1 also comprises at least one movable separator 6 which can move in a sealed manner inside the static measurement enclosure 3, a surface on the input volume side 7 of said separator 6 forming with said enclosure 3 a variable input volume 8 connected to the fluid inlet duct 4, and a surface on the output volume side 9 of said separator 6 forms with said enclosure 3 a variable output volume 10 connected to the fluid outlet duct 5.

It is to be noted that the movable separator 6 may in particular be a bladder, a bag or any other deformable container capable of storing fluid 2.

FIGS. 1 to 10 also show that the sequential volumetric flowmeter 1 according to the invention comprises at least one mobile return spring 11 which is directly or indirectly supported in the static measurement enclosure 3 to push or pull the movable separator 6 in the direction of the variable input volume 8.

The mobile return spring 11 tends, on the one hand, to reduce the internal volume of the variable input volume 8 and, on the other hand, to increase the pressure of the fluid 2 contained in said volume 8; said spring 11 can be helical, multi-turn corrugated, made up of a stack of elastic washers, or be of any type whatsoever known to those skilled in the art.

As can be seen in FIGS. 1 to 10, the sequential volumetric flowmeter 1 according to the invention further comprises at least one start-of-stroke static stop 12 fixed with respect to the static measurement enclosure 3, said stop 12 being capable to contact a movable start-of-stroke stop 13 fixed with respect to the movable separator 6, said two stops 12, 13 defining the minimum volume of the variable input volume 8 when they are in contact with one another.

Said flowmeter 1 also comprises at least one bypass valve 14 whose opening is controlled by a valve actuator 17, said valve 14 putting directly or indirectly, when it is open, the variable input volume 8 in communication with the output variable volume 10 via a transfer channel 59.

It is to be noted that the valve actuator 17 can be mechanical, electrical, electromagnetic, pneumatic, hydro-mechanical, piezoelectric, and in general, of any type known to those skilled in the art.

In FIGS. 1 to 10, are also shown the displacement measurement means 15 that comprises the sequential volumetric flowmeter 1 according to the invention, said means 15 providing information to a computer 16 about the position of the movable separator 6 with respect to the static measurement enclosure 3.

It should be noted that the displacement measurement means 15 may consist of any displacement, distance or position sensor, whether said sensor is of the absolute or incremental, resistive, potentiometric, capacitive, inductive, magneto-inductive type, eddy current type, laser-type optic or not, taut wire-type, and in general, of any type known to those skilled in the art.

It is also understood that the computer 16 can be more or less complex and that it can as such consist either of simple electrical components, or of sophisticated electronic and computer technologies, or of both.

It has been shown in FIGS. 1 to 6 that according to a particular embodiment of the sequential volumetric flowmeter 1 according to the invention, the movable separator 6 may consist of a separating piston 18 which moves in a separator cylinder 19 that forms the inside of the static measurement enclosure 3, piston sealing means 20 providing a seal between said piston 18 and said cylinder 19.

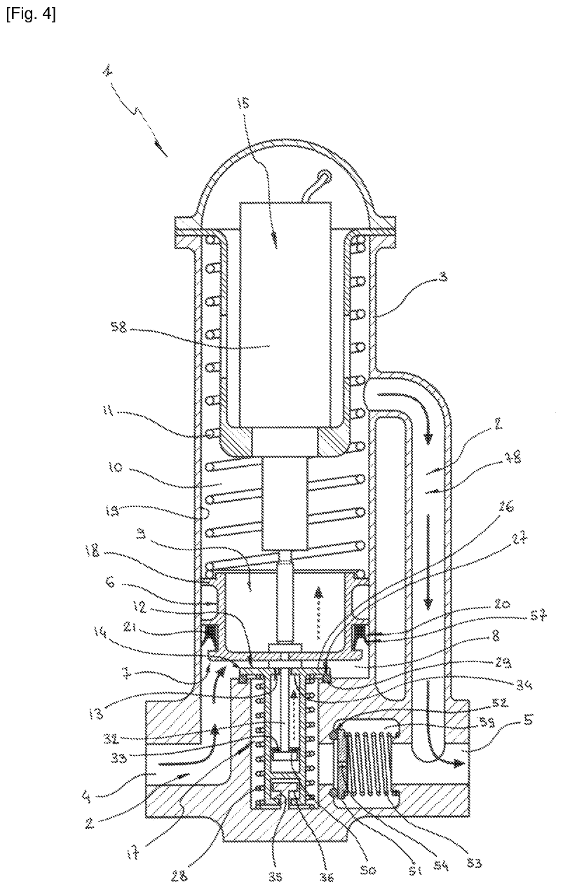

As seen in FIGS. 4 to 6, the piston sealing means 20 may for example consist of at least one seal 21 made of one or more elastomer and/or metal parts.

In FIGS. 1 to 3, it has also been shown that the piston sealing means 20 may consist of a flexible diaphragm 22 like those included in automotive brake assist master cylinders.

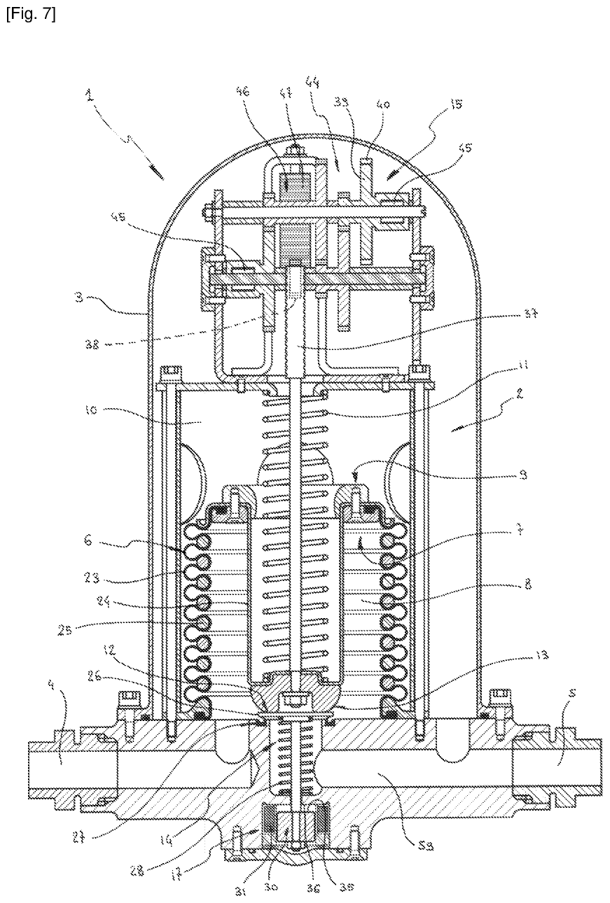

FIGS. 7 to 10 show that the movable separator 6 can consist of a separation gaiter 23, a first end of which is fixed in a sealed manner inside the static measurement enclosure 3, and the other end of which is sealed by a movable spring cup 24 on which the mobile return spring 11 bears.

It is to be noted that, as shown in FIGS. 7 to 10, one or more gaiter retaining rings 25 may be provided between the folds of the separation gaiter 23, said rings 25 preventing the gaiter 23 from inflating excessively under the effect of pressure.

FIGS. 1 to 10 show that according to an embodiment of the sequential volumetric flowmeter 1 according to the invention, the bypass valve 14 can include a bypass flap 26 which can sealingly bear on a flap seat 27 formed in the variable input volume 8 and fixed with respect to the static measurement enclosure 3, said flap 26 being capable to move away from said seat 27 by moving towards the inside of the variable input volume 8, whereas, when said flap 26 rests on said seat 27, the face of said flap 26 facing towards the variable input volume 8 forms the start-of-stroke static stop 12.

As a non-represented technological equivalent, it is to be noted that the bypass flap 26 can be fixed with respect to the movable separator 6 and rest in a sealed manner on a flap seat 27 fitted on the face located on the input volume side 7, said flap 26 forming, in this case, the start-of-stroke movable stop 13.

FIGS. 1 to 8 and 10 show that the flap seat 27 can expose an elastomeric ring 29 on which the bypass flap 26 can rest without impact, and as tightly as possible.

As shown in FIGS. 1 to 10, the bypass flap 26 may advantageously have a flap opening movable stop 35 which is capable to come into contact with a flap opening fixed stop 36 fixed with respect to the static measurement enclosure 3, the two stops 35, 36 determining, when they are in contact with each other, the maximum distance that can separate the bypass flap 26 from the flap seat 27 with which it cooperates.

It is also to be noted in FIGS. 1 to 10 that the sequential volumetric flowmeter 1 according to the invention may include a flap spring 28 which tends to move the bypass flap 26 away from the flap seat 27 with which it cooperates, the force produced by said spring 28 being less than the force exerted on the bypass flap 26 by the pressure of the fluid 2 contained in the variable input volume 8 when, on the one hand, said flap 26 rests on said seat 27, and that, on the other hand, this pressure is higher than that of fluid 2 contained in the variable output volume 10 as a result of the force exerted by the mobile return spring 11 on the movable separator 6.

As shown in FIGS. 1 to 3 and FIGS. 7, 8 and 10, the valve actuator 17 may consist of a magnetisable metal member 30 which is mechanically connected to the bypass flap 26, said member 30 being capable of imparting movement to said flap 26 when it is attracted by a magnetic field produced by an actuator coil 31 when the latter is traversed by an electric current controlled by the computer 16.

FIGS. 4 to 6 show another embodiment according to which the valve actuator 17 may consist of a lifting linkage 32 mechanically connected to the movable separator 6, said linkage 32 having at least one actuator lifting stop 33 which, firstly, contacts a valve lifting stop 34 fixed with respect to the bypass flap 26 when the variable inlet volume 8 has reached a predetermined volume and which then moves said flap 26 away from the flap seat 27 with which it cooperates as a result of the movement of the movable separator 6.

As illustrated in FIGS. 4 to 6, an unlocking spring 50 can advantageously be interposed between the actuator lifting stop 33 and the flap lift stop 34, said spring 50 facilitating the detachment of the bypass flap 26 from the flap seat 27 with which it cooperates when said flap 26 is urged to open by the movable separator 6.

As seen in FIGS. 4 to 6, the unlocking spring 50 can for example be configured as a spring washer known per se.

In FIGS. 4 to 6, it is also noted that the transfer channel 59 can be closed by a retaining flap 51 held in contact with a retaining seat 52 by a retaining spring 53, the latter letting said flap 51 move away from said seat 52 and open said channel 59 only as from a determined pressure, so that the fluid 2 coming from the variable input volume 8 circulates in said channel 59, while, at the same time, a retaining nozzle 54 allows said fluid 2 to pass through said channel 59 even when the retaining flap 51 is in contact with the retaining seat 52.

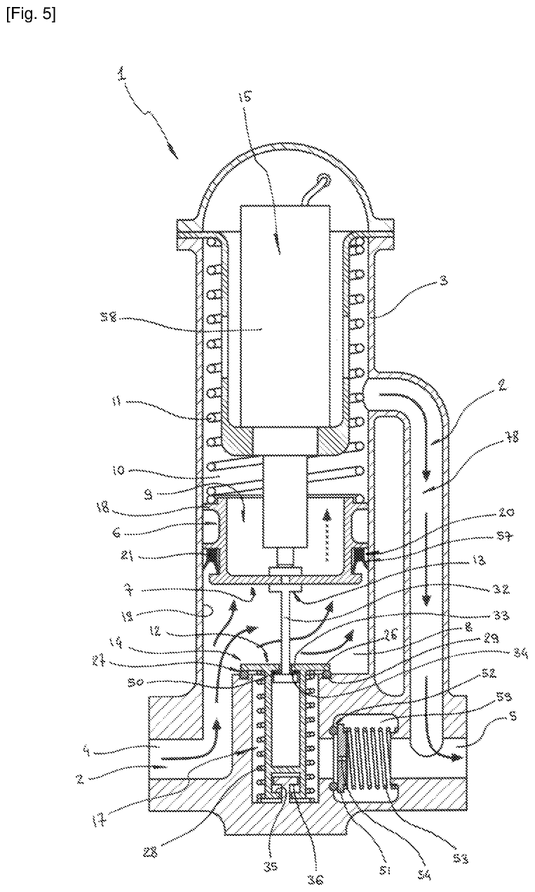

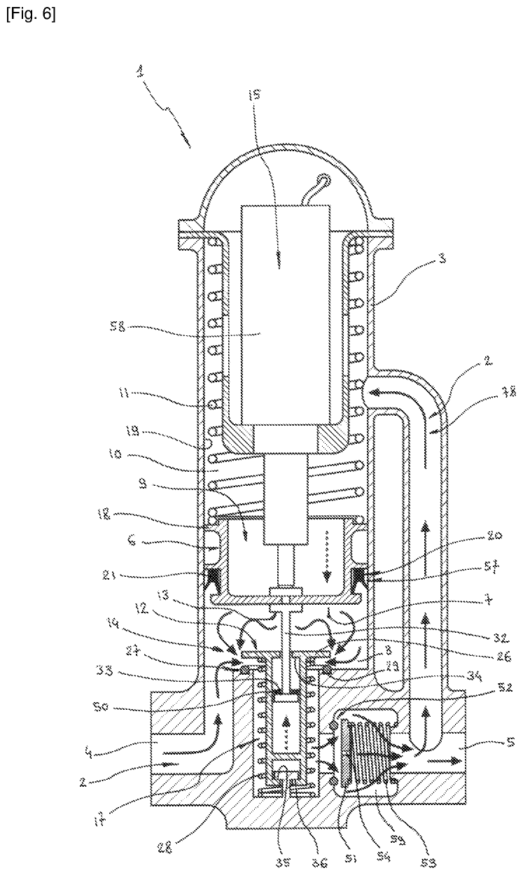

As will be understood by examining FIGS. 5 and 6, when the flap lift stop 34 begins to move the bypass flap 26 away from the flap seat 27, the retaining flap 51 allows a rapid pressure rise of the fluid 2 downstream of the bypass flap 26, which allows the flap spring 28 to detach said flap 26 from the flap seat 27 with which it cooperates.

When the start-of-stroke movable stop 13 presses again the bypass flap 26 on its flap seat 27, the retaining nozzle 54 depressurizes the volume located immediately downstream of the bypass flap 26 so as to ensure maintaining said flap 26 on said seat 27.

It is to be noted that if the valve actuator 17 is electric, pneumatic or of any type whatsoever, the retaining flap 51 prevents the bypass flap 26 from closing prematurely under the effect of the rapid movement of the fluid 2 in the transfer channel 59 when the movable separator 6 moves in the direction of the variable input volume 8 under the action of the mobile return spring 11.

As a particular embodiment of the sequential volumetric flowmeter 1 according to the invention, it is to be noted in FIGS. 7 to 10 that the displacement measurement means 15 may consist of a measurement rack 37 which is fixed with respect to the moveable separator 6 and which, when it moves with said separator 6, rotatably drives a measurement pinion 38 which in turn rotatably drives, directly or by means of a mechanical multiplier 44, an impulse wheel 39 fitted on its periphery with regularly distributed impulse generators 40.

In this case, the impulse wheel 39 cooperates with impulse sensing means 41 fixed with respect to the static measurement enclosure 3 and in front of which the impulse generators 40 pass, said sensing means 41 transforming the passage of each impulse generator 40 into an electrical signal transmitted to the computer 16.

It is to be noted that the impulse capture means 41 may for example consist of a light source received by a photosensitive sensor, the reception of light by said sensor being interrupted by the passage of the impulse generators 40 between said source and said sensor.

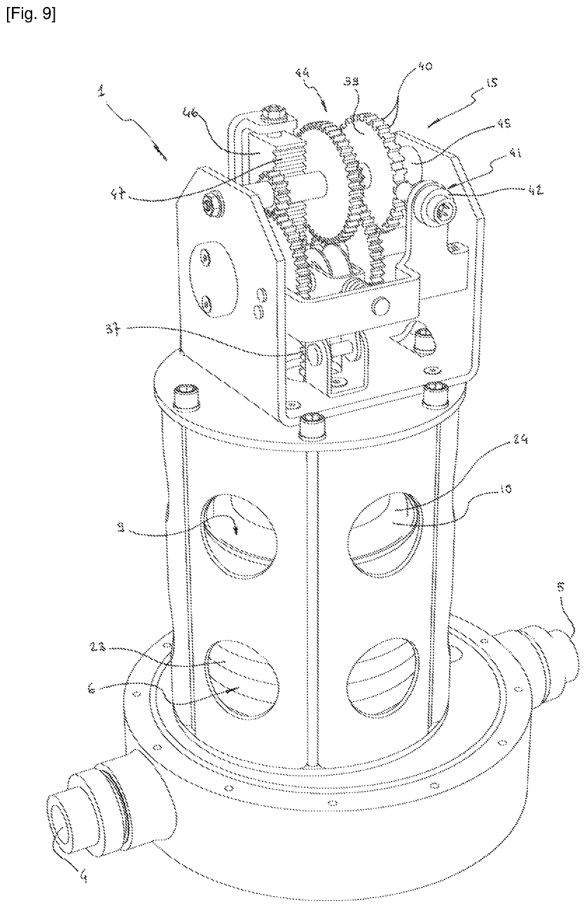

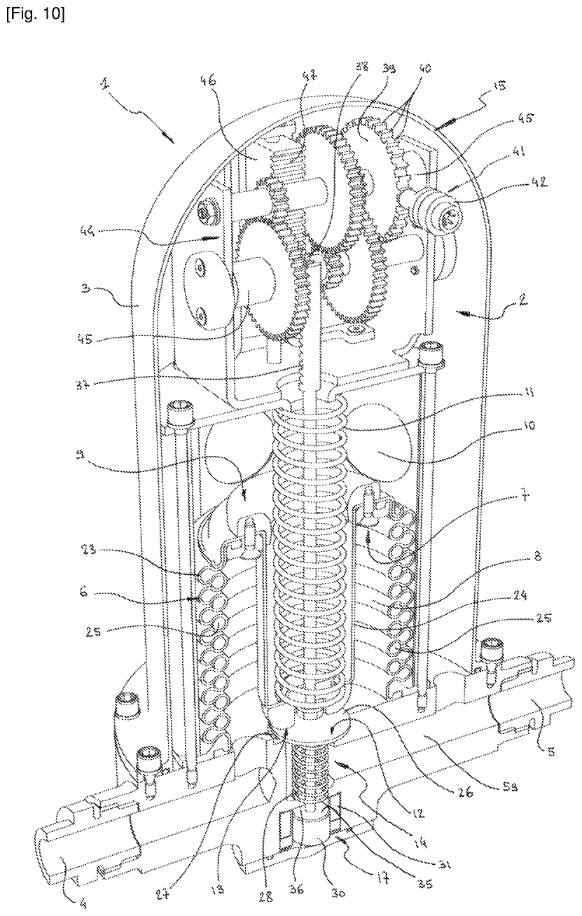

As a non-limiting embodiment shown in FIGS. 9 and 10, the impulse capture means 41 may consist of a “Hall” effect sensor 42 known per se, the impulse generators 40 being configured as impulse slots 43 which pass in front of said sensor.

It is to be noted that the measurement rack 37 and the measurement pinion 38 can be replaced by any other mechanical connection which can transform a linear movement into a rotational movement such as for example a cable which winds around a pulley, or a reversible wide-pitch screw which cooperates with a complementary internal thread, said screw and said internal thread being capable to come into contact with one another by means of circulating balls.

It is also to be noted that the mechanical multiplier 44 can consist of a succession of pinions as shown in FIGS. 7 to 10, of friction wheels, of one or more epicyclic gears, of a succession of toothed pulleys of different diameters connected by toothed belts, or any other type of mechanical multiplier 44 known to those skilled in the art.

Advantageously, the measurement pinion 38 and the pinion or pinions which may constitute the mechanical multiplier 44 may be provided with a play readjustment device known per se.

According to a particular embodiment of the sequential volumetric flowmeter 1 according to the invention, the measurement rack 37, the measurement pinion 38, the impulse wheel 39, the accessories thereof, and all or part of the impulse capture means 41 may be housed within the variable output volume 10, so that no sealed mobile connection is required between these various components 37, 38, 39, 41 and the inside of the output variable volume 10.

In this case, in order to partially occupy the empty space remaining in the variable output volume 10 and/or the variable input volume 8, one or more incompressible polymorphic parts may be housed in said volume 10, 8 which more or less accurately conform to said various components 37, 38, 39, 41 by touching or not touching the latter and in any case, without interfering with the proper functioning of the latter.

As clearly shown in FIG. 7, it is to be noted that the measurement pinion 38 can drive the impulse wheel 39 via a freewheel 45 which allows the pinion 38 to drive the impulse wheel 39 when the variable input volume 8 increases due to the displacement of the movable separator 6, but not when said volume 8 decreases.

According to this particular configuration, It may also be provided that the impulse wheel 39 is connected to the measurement static enclosure 3 by means of a freewheel 45 which allows the measurement wheel 39 to rotate in the direction of rotation imparted to it by the measurement pinion 38, but which prevents said wheel 39 to turn in the opposite direction.

It is to be noted that, as an alternative, this freewheel 45 can be replaced by a non-represented brake, the latter may also be advantageously added to said wheel 45 to prevent the rotational inertia of the impulse wheel 39 from being unduly interpreted by the computer 16 as a continuity of fluid flow 2 through the volumetric flowmeter sequential 1 according to the invention, even though said flow would have suddenly dropped, or even would have suddenly stopped.

According to another embodiment, a flywheel can be associated with the impulse wheel 39 either by directly weighting the latter or by connecting it to the flywheel by any mechanical link whatsoever.

Another embodiment of the sequential volumetric flowmeter 1 according to the invention shown in FIGS. 7 to 10 consists in the measurement pinion 38 driving, in addition to the impulse wheel 39 and by means of a balancing rack 47, a balancing mass 46 in longitudinal translation opposite the direction of the movement of the movable separator 6 which takes place simultaneously, the relative speed and weight of said mass 46 and said rack 47 being calculated so that when said mass 46 and the rack 47 move, they produce inertia forces of the same intensity as those produced at the same time by said separator 6 and the measurement rack 37 with which it cooperates.

This particular configuration of the sequential volumetric flowmeter 1 according to the invention makes it possible to make said flowmeter 1 insensitive to vibrations, for example when the latter is secured to a thermal internal combustion engine.

Indeed, the balancing mass 46 prevents the movable separator 6 from inadvertently moving relative to the static measurement enclosure 3 under the effect of said vibrations, which would have the consequence of making the flow reading of fluid 2 by the computer 16 false, or even impossible.

FIGS. 1 to 3 show that the displacement measurement means 15 can also consist of an impulse spindle 55 which is provided along its length with impulse generators 40, and which is fixed with respect to the movable separator 6, so that when said spindle 55 moves with said separator 6, the impulse generators 40 passing in front of impulse capture means 41 which are fixed with respect to the static measurement enclosure 3 and which transform the passage of each impulse generator 40 into an electrical signal transmitted to the computer 16.

As an alternative, the impulse spindle 55 may be fixed with respect to the static measurement enclosure 3 and the impulse capture means 41 be fixed with respect to the movable separator 6.

In FIGS. 1 to 3, it has been shown that the displacement measurement means 15 can consist of a separator end-of-stroke sensor 56 which is fixed with respect to the static measurement enclosure 3 or the movable separator 6, said sensor 56 transmitting an electrical signal to the computer 16 when the variable input volume 8 reaches a predefined maximum magnitude.

It is to be noted that the separator end-of-stroke sensor 56 can be a proximity sensor known per se, regardless of the type or principle of operation.

Still in FIGS. 1 to 3, it has also been shown that the movable separator 6 can be directly or indirectly connected to the static measurement enclosure 3 by a separator damper 57 which prevents said separator 6 from being subjected to large amplitude oscillations when the sequential volumetric flowmeter 1 according to the invention is subjected to vibrations, for example if said flowmeter 1 is fixedly secured to a reciprocating internal combustion engine 70.

As shown in FIGS. 1 to 3 and as a particular configuration of the sequential volumetric flowmeter 1 according to the invention, a pressure sensor 48 and/or a temperature sensor 49 can directly or indirectly measure the pressure and/or the temperature prevailing in the variable input volume 8 and/or the variable output volume 10, said two sensors 48, 49 allowing the computer 16 to determine the mass flow rate of the fluid 2 which passes through the sequential volumetric flowmeter 1 according to the invention from the information which is transmitted to said computer 16 by the displacement measurement means 15, and taking into account the force exerted by the mobile return spring 11 on the movable separator 6.

### Operation of the Invention:

The operation of the sequential volumetric flowmeter 1 according to the invention is easily understood by studying FIGS. 1 to 10, which show non-limiting embodiments of said flowmeter 1.

To explain said operation and initially, reference is made here to FIGS. 1 to 3 which show the sequential volumetric flowmeter 1 according to the invention as it can be used to implement the valve ignition pre-chamber 77 according to patent FR 3,061,743, on a reciprocating internal combustion engine 70.

It is shown in FIGS. 1 to 3, and schematically, the reciprocating internal combustion engine 70 which receives said valve ignition pre-chamber 77 supplied with pilot charges 73 by a stratification injector 80.

Said pilot charges 73 are, by way of non-limiting example, formed of an easily flammable gas mixture consisting of a proportion of fourteen grams of air 78 per gram of gasoline 79.

This gas mixture is therefore slightly rich compared to stoichiometry, and is made in an air-gasoline 74 mixer fed, on the one hand, with gasoline 79 under a pressure of forty bars, from a fuel tank 71 via a fuel pump 72, and, on the other hand, with atmospheric air 78 by an air compressor 75 via an air filter 81, the inlet pressure of that compressor 75 being regulated by a throttle casing 82.

The air-gasoline mixer 74 produces a homogeneous mixture of said air 78 and said gasoline 79, the latter having to remain entirely in the gaseous state despite the pressure of forty bars to which it is subjected.

It should be noted that an air-gasoline mixer 74 fulfilling all the functions necessary to supply the pilot charge 73 of the valve ignition pre-chamber 77 according to the patent FR 3,061,743 was the subject-matter of patent application FR 2004269, filed on Apr. 29, 2020 by the Applicant, titled “Forced Recirculation Mixer”.

In FIGS. 1 to 3, can be noted the presence of a computer 16 in particular for controlling the stratification injector 80, the different functions of the air-gasoline mixer 74, and the throttle casing 82.

The throttle casing 82 makes it possible to maintain the pressure of forty bars downstream of compressor 75 regardless of the speed and load of the reciprocating internal combustion engine 70, and regardless of the amount of pilot charge 73 introduced by the stratification injector 80 into the valve ignition pre-chamber 77 at each thermodynamic cycle of said engine 70.

FIGS. 1 to 3 also show a pressure sensor 48 and a temperature sensor 49 which, respectively, transmit to computerl6 the pressure and temperature of air 78 found at the inlet of the liquid inlet duct 4 of the sequential volumetric flowmeter 1 according to the invention.

According to the particular embodiment of this flowmeter 1 shown in FIGS. 1 to 3, the movable separator 6 consists of a separating piston 18 which moves in a separator cylinder 19 which is formed by the inside of the static measurement enclosure 3.

FIGS. 1 to 3 also show the mobile return spring 11, which bears in the static measurement enclosure 3 so as to push the separating piston 18 in the direction of the variable input volume 8, said spring 11 tending to increase the pressure of the fluid 2 contained in said volume 8.

FIGS. 1 to 3 show that the piston sealing means 20 which provide a seal between the separating piston 18 and the cylinder separator 19 consist of a flexible diaphragm 22 similar to those of the automotive brake assist master-cylinders.

In FIGS. 1 to 3, It is also to be noted that the separating piston 18 is connected to the static measurement enclosure 3 by a separator damper 57 which prevents said piston 18 from being subjected to parasitic oscillations capable of distorting the air flow measurement 78 by the sequential volumetric flowmeter 1 when the reciprocating internal combustion engine 70 transmits vibrations to it.

It can be seen in FIGS. 1 to 3 that the displacement measurement means 15 consist in particular of an impulse spindle 55 provided over its length with impulse generators 40. Said spindle 55 is fixed with respect to the separating piston 18 so that when the latter moves relative to the static measurement enclosure 3, the impulse generators 40 pass one after the other in front of a “Hall” effect sensor 42 fixed with respect to said enclosure 3, said sensor 42 transforming the passage of each impulse generator 40 into an electrical signal which is transmitted to the computer 16.

In addition to said impulse spindle 55, it can be seen in FIGS. 1 to 3 that the displacement measurement means 15 includes a separator end-of-stroke sensor 56 fixed with respect to the static measurement enclosure 3.

When the impulse spindle 55 approaches said sensor 56 at a distance, for example less than one millimeter, said sensor 56 provides the related information to the computer 16 by means of an electrical signal.

According to the particular embodiment of the sequential volumetric flowmeter 1 according to the invention shown in FIGS. 1 to 3, the bypass valve 14 comprises a bypass flap 26 which can sealingly rest on a flap seat 27, the latter being arranged in the variable input volume 8 and fixed with respect to the static measurement enclosure 3.

It is to be noted that the bypass flap 26 can move away from the flap seat 27 by moving towards the inside of the variable input volume 8, and this as long as it is not stopped along its movement by the flap opening movable stop 35 which said flap 26 has.

It is to be noted that the flap opening movable stop 35 cooperates with a flap opening fixed stop 36 fixed with respect to the static measurement enclosure 3, said two stops 35, 36 determining, when they are in contact from each other, the maximum distance that can separate the bypass flap 26 from the flap seat 27.

It is also to be noted that when the bypass flap 26 rests on the flap seat 27, its face oriented towards the variable input volume 8 forms a start-of-stroke static stop 12 which cooperates with a start-of-stroke movable stop 13 fixed with respect to the separating piston 18, said two stops 12, 13 defining the minimum volume of the variable input volume 8 when they are in contact with one another.

It is to be noted that the lifting of the bypass flap 26 from the flap seat 27 on which it rests is done by means of a valve actuator 17.

Said actuator 17 is here and as a non-imitative example consisting of a magnetisable metal member 30 which, in FIGS. 1 to 3, is configured as a magnetic pallet 83 mechanically connected to the bypass flap 26.

The magnetic pallet 83 can thus lift the bypass flap 26 from the seat 27 on which it rests, which happens when said pallet 83 is attracted by the magnetic field produced by an actuator coil 31 when the latter is crossed by an electric current controlled by the computer 16.

In FIG. 1 is depicted the sequential volumetric flowmeter 1 according to the invention in the filling phase of the variable input volume filling 8.

During this filling phase, the air 78 discharged from the air compressor 75 is introduced into the variable input volume 8 by the fluid inlet duct 4.

Provided the bypass flap 26 rests on its flap seat 27, the introduction of air 78 through the fluid inlet duct 4 causes the separating piston 18 to go back and the variable input volume 8 to increase.

At the same time, the variable output volume 10 decreases and expels the air 78 it contains through the fluid outlet duct 5.

It should be noted that since the separating piston 18 is pushed in the direction of the variable input volume 8 by the mobile return spring 11, the pressure prevailing in the variable input volume 8 is higher than that prevailing in the output variable volume 10.

Due to the non-null stiffness of the mobile return spring 11, the pressure difference between the variable input volume 8 and the variable output volume 10 is all the more important as said spring 11 is compressed.

We will assume here that the pressure difference is one hundred millibars at the beginning of the ascending stroke of the separating piston 18, and two hundred millibars at the end of said stroke.

Throughout the ascending stroke of the separating piston 18, the impulse generators 40 that the impulse spindle 55 has pass one after the other in front of the “Hall” effect sensor 42, the latter transmitting the electrical signals corresponding to the computer 16.

Knowing the time elapsed between two signals of passage of the impulse generator 40, the computer 16 can calculate the volume flow rate of air 78 passing through the fluid inlet duct 4, said flow rate being equal to the product of the section of separating piston 18 by the speed of said piston 18.

To calculate the mass flow rate of air 78 passing through the fluid inlet duct 4, the computer 16 takes into account the pressure and the temperature which are respectively transmitted to it by the pressure sensor 48 and the temperature sensor 49. In fact, the mass flow rate of air 78 corresponds to the product of the volume flow rate of said air 78 by the density of said air 78, the latter resulting from the product of the pressure of said air 78 by the temperature of said air 78.

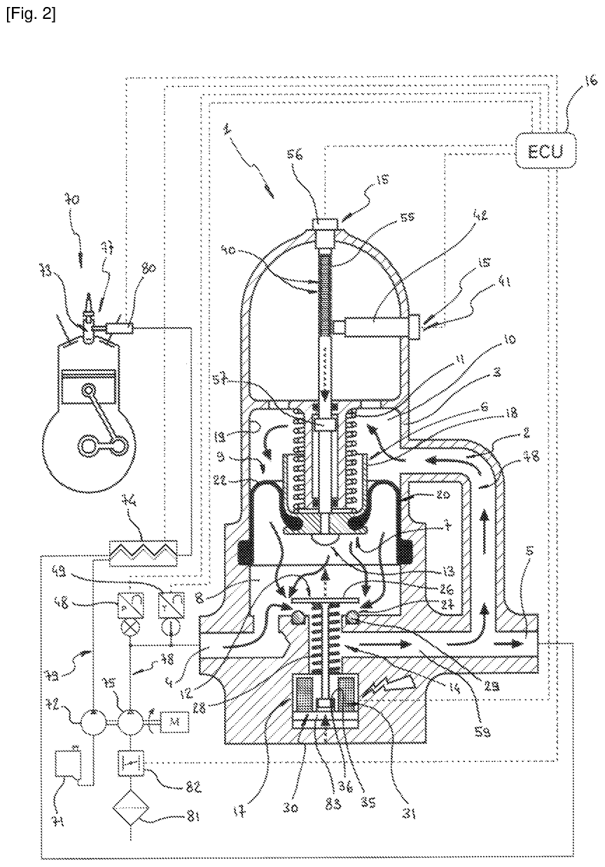

When the separating piston 18 reaches its top dead center, as shown in FIG. 2, the separator end-of-stroke sensor 56 sends an electrical signal to the computer 16 which triggers the opening of the bypass flap 26 by means of the actuator coil 31.

It is to be noted that until now, the bypass flap 26 was kept pressed against the flap seat 27 with which it cooperates by the pressure prevailing in the variable input volume 8 which was always greater of one hundred to two hundred millibars than that prevailing in the variable output volume 10.

In fact, said difference has hitherto applied over the entire surface included within the line of contact formed by the bypass flap 26 with the flap seat 27, said difference exerting on said flap 26 a force greater than that exerted by the flap spring 28 which tends to move said flap 26 away from the flap seat 27.

The separating piston 18 having reached its top dead center, when the bypass flap 26 is lifted and then moved away from its flap seat 27 by the actuator coil 31, the pressure difference between the variable input volume 8 and the variable output volume 10 suddenly becomes small to the point that the flap spring 28 can hold the bypass flap 26 open throughout the descending stroke of the separating piston 18.

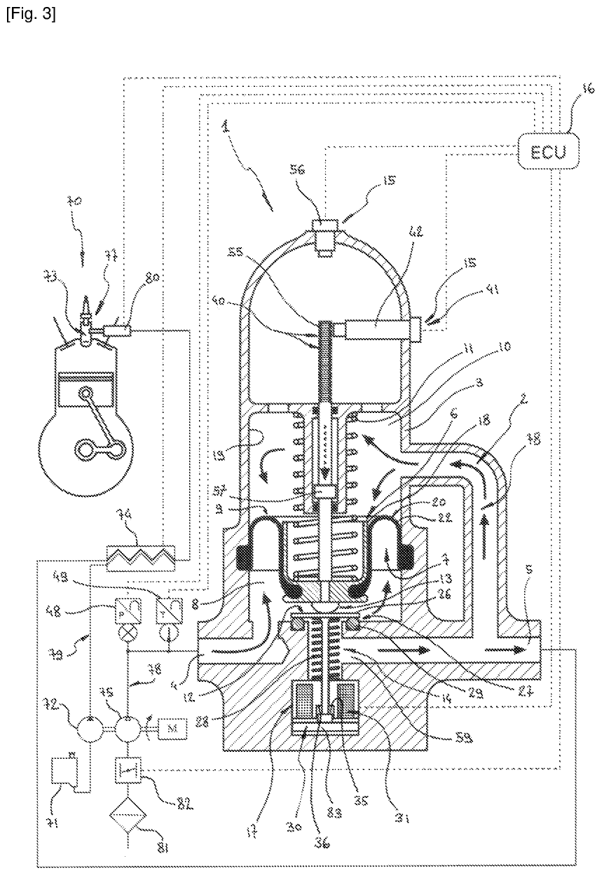

When the separating piston 18 has reached its bottom dead center, as shown in FIG. 3, the movable start-of-stroke stop 13 which it has first came into contact with the start-of-stroke static stop 12 formed by the bypass flap 26, then forced said flap 26 to return in contact with the flap seat 27 in a sealed manner.

The bypass flap 26 being again closed and sealed, a new cycle of measuring the volume flow of air 78 can resume, which leads again to the situation shown in FIG. 1.

It should be noted that the computer 16 can detect when the separating piston 18 has reached its bottom dead center, which occurs, on the one hand, after the triggering of the opening of the bypass flap 26 by said computer 16 by means of the actuator coil 31, and, on the other hand, after the reception by the aforementioned computer 16 of temporally very close signals of the passage of the impulse generators 40, said signals being sent to said computer 16 by the “Hall” effect sensor 42.

The termination of these close signals may also coincide with the minimum pressure detected by the pressure sensor 48. From this information, the computer 16 can exclude the descending stroke of the separating piston 18 from the air flow 78 calculation, and determine the average flow of the air 78 flowing through the sequential volumetric flowmeter 1 only from the signals 40 resulting of the passing of the impulse generators in front of the “Hall” sensor 42, which are received during the ascending stroke of the separating piston 18.

The exclusion of the descending stroke of the separating piston 18 from the calculation of the average flow of the air 78 by the computer 16 is always necessary regardless of the configuration of the sequential volumetric flowmeter 1 according to the invention, whether such exclusion is mechanical or performed by software.

It should be noted that this exclusion is easier to achieve when the measurement displacement means 15 consist, for example, of a potentiometric displacement sensor 58 as shown in FIGS. 4 to 6. Indeed, according to this particular configuration of the sequential volumetric flowmeter 1 according to the invention, the computer 16 is at any moment informed about the position of the separating piston 18 relative to that of the static measurement enclosure 3.

FIGS. 4 to 6 also show that the movable separator 6 is configured as a separating piston 18 which differs from that shown in FIGS. 1 to 3 in that the piston sealing means 20 it has consist of a lip sealing gasket 21, known per se. Said sealing gasket 21, whether pre-lubricated or of the dry-operating type, induces in any cases friction losses due to its contact with the separator cylinder 19 and, as such, it fully or partly performs the function of separator damper 57.

The particular embodiment of the sequential volumetric flowmeter 1 according to the invention shown in FIGS. 4 to 6 further provides that the valve actuator 17 no longer consists of a magnetic pallet 83 attracted by an actuator coil 31, but a lifting linkage 32 mechanically connected to the separating piston 18.

The lifting linkage 32 has an actuator lifting stop 33 which initially comes into contact with a flap lift stop 34 fixed with respect to the bypass flap 26 when the separating piston 18 is close to its top dead center, and which, in a second time, moves said flap 26 away from the flap seat 27 with which it cooperates as a result of the displacement of the separating piston 18 up to its top dead center.

FIGS. 4 to 6 also show the release spring 50 which is interposed between the actuator lifting stop 33 and the flap lift stop 34 and facilitates the detachment of the bypass flap 26 from the flap seat 27 when the flap 26 is caused to open by the separating piston 18 via said stops 33, 34.

FIGS. 4 to 6 also show the retaining flap 51 located in the transfer channel 59 and kept in contact with a retaining seat 52 by a retaining spring 53, the latter letting said flap 51 move away from said seat 52 and open said channel 59 only as from a determined pressure.

Thus, and as can be readily deduced from FIGS. 5 and 6, when the valve lift stop 34 begins to move the bypass flap 26 away from the flap seat 27, the flap 51 allows a rapid rise of the pressure of the air 78 located immediately downstream of the bypass flap 26, which allows in any case the flap spring 28 to detach said flap 26 from the flap seat 27 with which it cooperates.

FIGS. 4 to 6 also show that the retainer flap 51 is pierced so as to form a retainer nozzle 54, which allows air 78 to pass through the transfer channel 59 even when the retainer flap 51 is in contact with the retainer seat 52.

The retaining nozzle 54 makes it possible that when the start-of-stroke movable stop 13 presses again the bypass flap 26 on the flap seat 27, the pressure in the volume immediately downstream of said flap 26 drops so that said flap 26 remains well pressed against the flap seat 27 when the separating piston 18 goes again in the ascending stroke.

Another embodiment of the sequential volumetric flowmeter 1 according to the invention is shown in FIGS. 7 to 10. In this embodiment, the movable separator 6 consists of a separation gaiter 23, of which a first end is sealingly fixed inside the static measurement enclosure 3, and the other end is sealingly closed by a mobile spring cup 24 on which the mobile return spring 11 bears.

According to the particular configuration shown in FIGS. 7 to 10, the displacement measurement means 15 consist of a measurement rack 37 which is fixed with respect to the movable spring cup 24 and which, when it moves with said cup 24, rotatably drives a measurement pinion 38 which in turn rotatably drives and by means of a mechanical multiplier 44 an impulse wheel 39 provided at its periphery with regularly distributed impulse generators 40.

As can be seen clearly on pages 9 and 10, the impulse wheel 39 cooperates with a “Hall” effect sensor 42 which is fixed with respect to the static measurement enclosure 3 and in front of which the impulse generators 40 of said wheel 39 pass, said sensor 42 transforming the passage of each impulse generator 40 into an electrical signal transmitted to the computer 16.

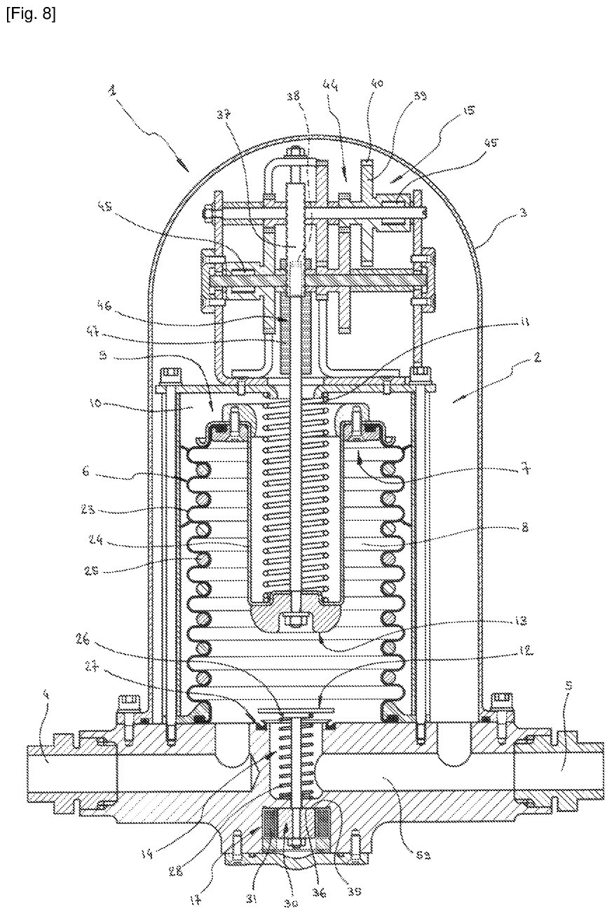

In FIG. 8, it can be clearly seen that the measurement pinion 38 drives the impulse wheel 39 via a freewheel 45.

This first freewheel 45 allows on the one hand, the measurement pinion 38 to drive the impulse wheel 39 when the variable input volume 8 increases but not when said volume 8 decreases, and, on the other hand, to let the impulse wheel 39 continue to rotate on its momentum when the variable input volume 8 decreases rapidly following the opening of the bypass flap 26.

In FIG. 8, it is to be noted that a second freewheel 45 connects the impulse wheel 39 to the static measurement enclosure 3. Said second freewheel 45 allows the impulse wheel 39 to rotate in the direction of rotation that the measurement pinion 38 imparts on it, but prevents it from turning in the opposite direction.

The main advantage of the displacement measurement means 15 shown in FIGS. 7 to 10 lies in the high precision in measuring the displacement of the movable separator 6 that they provide thanks to the mechanical multiplier 44.

Indeed, said multiplier 44 and the freewheels 45 with which it cooperates allow the impulse wheel 39 to turn rapidly and to transmit to the “Hall” effect sensor 42 many impulses per unit of displacement of the movable separator 6, and this without affecting the speed of return to bottom dead center of said separator 6. Said high precision is obtained with simple and inexpensive mechanical and electronic means.

It is to be noted that regardless the embodiment used for the sequential volumetric flowmeter 1 according to the invention, its calibration can be carried out during its development, or apparatus by apparatus at the end of the process of manufacture, by means of a standard flowmeter. According to this method, it is possible to associate, with each effective flow rate recorded by the standard flowmeter, a behavior of the sequential volumetric flowmeter 1 according to the invention, and then to store the corresponding transfer rule in the computer 16.

It should be noted that the examples of embodiments of the sequential volumetric flowmeter 1 according to the invention described above are not limitative.

It should also be noted that this flowmeter 1 according to the invention can be applied to fields other than that of internal combustion engines, such as chemistry, industrial processes or any apparatus in any field whatsoever that requires the measurement of the volume and/or mass flow rate of a fluid 2, whatever is the nature of the fluid, and whatever is the liquid or gaseous state of the fluid.

The possibilities of the sequential volumetric flowmeter 1 according to the invention are not limited to the applications described above and it must be understood that the above description was given only as an example and that it does not limit the field in any way of said invention which would not be taken out by replacing the details of execution described by any other equivalent.

1. Sequential volumetric flowmeter (1) for measuring flow rate of a fluid (2) comprising:
a static measurement enclosure (3) connected both to a fluid inlet duct (4) through which the fluid (2) enters the enclosure (3), and also to a fluid outlet duct (5) through which the fluid (2) exits the enclosure (3);
at least one movable separator (6) which can move in a sealed manner inside the static measurement enclosure (3), one surface located on the input volume side (7) of said separator (6) forming with said enclosure (3) a variable input volume (8) connected to the fluid inlet (4), and one surface located on the output volume side (9) of said separator (6) forming with said enclosure (3) a variable output volume (10) connected to the fluid outlet duct (5);
at least one mobile return spring (11) which bears directly or indirectly in the static measurement enclosure (3) to push or pull the movable separator (6) in the direction of the variable input volume (8), said spring (11) tending both to reduce the internal volume of the variable input volume (8), and also to increase the pressure of the fluid (2) contained in said volume (8);
at least one start-of-stroke static stop (12) fixed with respect to the static measurement enclosure (3), said stop (12) being capable to come into contact with a movable start-of-stroke stop (13) fixed with respect to the movable separator (6), the two stops (12, 13) defining the minimum volume of the variable input volume (8) when they are in contact with one another;
at least one bypass valve (14) the opening of which is controlled by a valve actuator (17), said valve (14) putting directly or indirectly, when the valve is open, the variable input volume (8) in communication with the variable output volume (10) via a transfer channel (59);
displacement measurement means (15) which provide information to a computer (16) on the position of the movable separator (6) relative to the static measurement enclosure (3).

2. The sequential volumetric flowmeter of claim 1, wherein the movable separator (6) consists of a separating piston (18) which moves in a separator cylinder (19) which is formed by the inside of the static measurement enclosure (3), piston sealing means (20) providing a seal between said piston (18) and said cylinder (19).

3. The sequential volumetric flowmeter of claim 2, wherein the piston sealing means (20) consists of a flexible diaphragm (22).

4. The sequential volumetric flowmeter of claim 1, wherein the movable separator (6) consists of a separation gaiter (23), one end of which being fixed in a sealed manner inside the static measurement enclosure (3), and the other end of which being sealed by a movable spring cup (24) on which bears the mobile return spring (11).

5. The sequential volumetric flowmeter of claim 1, wherein the bypass valve (14) comprises a bypass flap (26) which can rest in a sealed manner on a flap seat (27) formed in the variable input volume (8) and fixed with respect to the static measurement enclosure (3), said flap (26) being capable to move away from said seat (27) by moving towards the interior of the variable input volume (8), whereas, when said flap (26) rests on said seat (27), the flap's face oriented towards the variable input volume (8) forms the start-of-stroke static stop (12).

6. The sequential volumetric flowmeter of claim 5, wherein the bypass flap (26) has a flap opening movable stop (35) which can come into contact with a flap opening fixed stop (36) fixed with respect to the static measurement enclosure (3), the two stops (35, 36) determining, when they are in contact with each other, the maximum distance which can separate the bypass flap (26) from the flap seat (27) with which the bypass flap cooperates.

7. The sequential volumetric flowmeter of claim 5, wherein a flap spring (28) tends to move the bypass flap (26) away from the flap seat (27) with which the bypass flap cooperates, the force produced by said spring (28) being less than the force exerted on the bypass flap (26) by the pressure of the fluid (2) contained in the variable input volume (8) when both said flap (26) rests on said seat (27), and also said pressure is greater than that of the fluid (2) contained in the variable output volume (10) as a result of the force exerted by the mobile return spring (11) on the movable separator (6).

8. The sequential volumetric flowmeter of claim 5, wherein the valve actuator (17) consists of a magnetizable metal member (30) which is mechanically connected to the bypass flap (26), said magnetizable metal member (30) being capable of imparting movement to said flap (26) when said magnetizable metal member is attracted by a magnetic field produced by an actuator coil (31) when the actuator coil is traversed by an electric current.

9. The sequential volumetric flowmeter of claim 5, wherein the valve actuator (17) consists of a lifting linkage (32) mechanically connected to the movable separator (6), said linkage (32) having at least one actuator lifting stop (33) which, firstly, contacts a flap lift stop (34) fixed with respect to the bypass flap (26) when the variable input volume (8) has reached a predetermined volume, and which then moves the flap (26) away from the flap seat (27) with which the flap cooperates as a result of the movement of the movable separator (6).

10. The sequential volumetric flowmeter of claim 5, wherein the transfer channel (59) is closed by a retaining flap (51) held in contact with a retaining seat (52) by a retaining spring (53), the retaining spring letting said flap (51) move away from said seat (52) and open said channel (59) only as from a determined pressure, so that the fluid (2) coming from the variable input volume (8) circulates in said channel (59), while, at the same time, a retaining nozzle (54) allows said fluid (2) to pass through said channel (59) even when the retaining flap (51) is in contact with the retaining seat (52).

11. The sequential volumetric flowmeter of claim 1, wherein the displacement measurement means (15) consist of a measurement rack (37) which is fixed with respect to the movable separator (6) and which, when moving with said separator (6), rotatably drives a measurement pinion (38) which in turn rotatably drives, directly or by means of a mechanical multiplier (44), an impulse wheel (39) whose periphery is fitted with regularly distributed impulse generators (40), said wheel (39) cooperating with impulse sensing means (41) fixed with respect to the static measurement enclosure (3) and in front of which the impulse generators (40) pass, said sensing means (41) transforming the passage of each impulse generator (40) into an electrical signal transmitted to the computer (16).

12. The sequential volumetric flowmeter of claim 11, wherein the measurement pinion (38) drives the impulse wheel (39) via a freewheel (45).

13. The sequential volumetric flowmeter of claim 12, wherein the impulse wheel (39) is connected to the static measurement enclosure (3) via a freewheel (45).

14. The sequential volumetric flowmeter of claim 11, wherein the measurement pinion (38) drives, in addition to the impulse wheel (39) and by means of a balancing rack (47), a balancing mass (46) in longitudinal translation opposite the direction of the movement of the movable separator (6) which takes place simultaneously, the relative speed and weight of said mass (46) and said rack (47) being calculated so that when said mass (46) and said rack (47) move, they produce inertia forces of the same intensity as those produced at the same time by said separator (6) and the measurement rack (37) with which said separator cooperates.

15. The sequential volumetric flowmeter of claim 1, wherein the displacement measurement means (15) consist of an impulse spindle (55) which is provided with impulse generators (40) along the impulse spindle's length, and which is fixed with respect to the movable separator (6) so that when said spindle (55) moves with said separator (6), the impulse generators (40) passing in front of impulse capture means (41) which are fixed with respect to the static measurement enclosure (3) and which transform the passage of each impulse generator (40) into an electrical signal transmitted to the computer (16).

16. The sequential volumetric flowmeter of claim 1, wherein the displacement measurement means (15) consist of a separator end-of-stroke sensor (56) which is fixed with respect to the static measurement enclosure (3) or to the movable separator (6), said sensor (56) transmitting an electrical signal to the computer (16) when the variable input volume (8) reaches a predefined maximum magnitude.

17. The sequential volumetric flowmeter of claim 1, wherein the movable separator (6) is directly or indirectly connected to the static measurement enclosure (3) by a separator damper (57).

18. The sequential volumetric flowmeter of claim 1, further comprising a pressure sensor (48) and/or a temperature sensor (49) which directly or indirectly measures the pressure and/or temperature prevailing in the variable input volume (8) and/or variable output volume (10).
